(19) United States
(12) Patent Application Publication
(10) Pub. No.: US 2014/0252900 A1
(43) Pub. Date: Sep. 11, 2014

(54) DC Homopolar Generator with Drum Wound Air Coil Cage and Radial Flux Focusing

(71) Applicant: Robert T. Mandes, Groton, CT (US)

(72) Inventor: Robert T. Mandes, Groton, CT (US)

(21) Appl. No.: 14/200,979

(22) Filed: Mar. 7, 2014

Related U.S. Application Data
(60) Provisional application No. 61/773,960, filed on Mar. 7, 2013.

(51) Int. Cl. H02K 21/36; H02K 1/17

(52) U.S. Cl. CPC H02K 21/36; H02K 1/17
USPC 310/154.29; 310/178

(57) ABSTRACT

An improved air core homopolar generator is provided. The improved homopolar generator employs a stator having an outer ring for bifurcating magnetic flux flow and multiple flux focusing magnets arranged around a common axis. The improved homopolar generator also includes an inner flux transmitter coaxial with the common axis.

### CROSS-REFERENCE TO RELATED APPLICATIONS

The present application is related to, claims the earliest available effective filing date(s) from, and incorporates by reference in its entirety all subject matter of the following listed application(s) (the “Related Applications”) to the extent such subject matter is not inconsistent herewith; and the present application also claims the earliest available effective filing date(s) from, and also incorporates by reference in its entirety all subject matter of any and all parent, grandparent, great-grandparent, etc. applications of the Related Application(s) to the extent such subject matter is not inconsistent herewith:

U.S. patent application 61/773,960, entitled “DC Homopolar Generator with Drum Wound Air Coil Cage and Radial Flux Focusing”, naming Robert T. Mandes as inventor, filed 7 Mar. 2013.

### BACKGROUND

1. Field of Use

This invention relates to an improved homopolar generator. More specifically, the invention relates to an improved direct current homopolar generator with flux condensing.

2. Description of Prior Art (Background)

Homopolar machines, and in particular generators, differ from other machines in that the armature conductors are arranged with respect to the magnetic flux path such that the armature conductors will always cut across or intersect the magnetic field in the same direction. Thus, in the case of homopolar generators, a direct current may be generated, without the need of commutators.

A simple prior art homopolar generator 10 is shown in FIG. 1. This generator 10 utilizes a disc 12 rotating on its axis and intersecting the magnetic flux path 14. The magnet 15 forms the magnetic flux path 14 and generates the magnetic flux φ. It is known that the rotation of the disc 12 in this manner generates an electrical potential between radially distinct portions of the disc 12 while there is magnetic flux passing through the magnetic flux path 14. In particular, an electrical potential will be induced between the center 16 of the disc 12 and the circumference 18 of the disc. In FIG. 1, the electrical energy thus generated is removed by means of brushes 20 and 22.

In other prior art devices, a conducting drum 24 is used in place of a disc 12, as shown in FIG. 2. The conducting drum 24 rotates on its longitudinal axis and intersects the magnetic flux path 26 thereby generating an electrical potential between axially distinct portions on the drum 24 and in particular between the ends 28, 30. The magnetic flux path 26 is defined by the core 25 which has a low magnetic reluctance. The magnetic flux is generated by the exciting winding 27. Since the drum 24 is rotating, the electricity is removed by means of brushes 32, 34 located near the ends 28, 30, similar to the case of the disc 12.

Homopolar inefficiencies, most importantly, also include: 1.) Produces only “current” and very little controlled “voltage” due to the absence of “coils”, etc. Also the current produced may be greatly reduced due to resistance of commutation, etc.,

One of the disadvantages associated with conventional homopolar machines is the magnetic flux φ tends to be uniformly shaped resulting in magnetic leakage flux which does not cross the air gap and link the stator winding, thus providing no useful magnetic field.

Another disadvantage with conventional homopolar machines is the efficiency of the machine is significantly reduced by the effects of eddy currents associated with non air core generators.

### BRIEF SUMMARY

The foregoing and other problems are overcome, and other advantages are realized, in accordance with the presently preferred embodiments of these teachings.

In accordance with one embodiment of the present invention a direct current homopolar generator is provided. The DC homopolar generator includes a conjoined toroid shaped armature, wherein the conjoined toroid shaped armature is magnetic and generates focused unidirectional magnetic flux lines. In addition the DC homopolar generator includes an electrically conductive, coreless, wire coil cage disposed within the conjoined toroid shaped armature, wherein the unidirectional magnetic flux lines are substantially perpendicular to the electrically conductive wire coil cage.

The invention is also directed towards a stator having an outer ring for bifurcating magnetic flux flow and curved magnets adjacent an inner curve of the outer ring. An inner flux transmitter enables magnetic flux flow between the curved magnets and across air gaps wherein conductors are rotated through the air gaps and bisect the magnetic flux at substantially 90 degrees.

In accordance with another embodiment the invention is also directed towards a direct current homopolar which includes a stator structure. The stator structure includes an outer ring for bifurcating and conducting magnetic flux. The outer ring includes an inner surface and a first outer magnet having first and second opposing surfaces, wherein the first opposable surface is attachable to the inner surface of the outer ring. Attachable to the second opposable surface of the first outer magnet is an outer ferrous concave cap. On the opposite side of the ring there is a similar arrangement. In the center of the ring is a ferrous shaft bearing and inner magnets for continuing the flux path across the center of the stator structure and around a drive shaft. The inner and outer magnets are capped with convex and concave surfaces as suitable to shape the magnetic flux path across a gap between the inner and outer magnets. Also included is a rotor structure comprising a plurality of conductive windings where each winding is adaptable to rotate through the gaps in a plane substantially orthogonal to the magnetic flux plane.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 is an illustration of a prior art homopolar generator having a disc shaped armature;

FIG. 2 is an illustration of a prior art homopolar generator having a drum shaped armature;

FIG. 3 is an illustration of a homopolar generator having a drum shaped armature and magnetic flux path focusing features in accordance with one embodiment of the present invention;

FIG. 4 is an illustration of a homopolar generator having a conjoined toroid shaped armature and magnetic flux path focusing features in accordance with another embodiment of the present invention;

FIG. 4A is a close up illustration of the homopolar generator having a conjoined toroid shaped armature and magnetic flux path focusing features shown in FIG. 4;

FIG. 5 is a diagram of the magnetic flux resulting from the armature shown in FIG. 3;

FIG. 6 is a pictorial cross section of an end view of the coil cage shown in FIG. 4;

FIG. 7 is an illustration of a homopolar generator having a drum shaped armature and magnetic flux path focusing features in accordance with an embodiment of the present invention shown in FIG. 3;

FIG. 8 is an illustration of a 120 degree version of the homopolar generator having a drum shaped armature and magnetic flux path focusing features in accordance with an embodiment of the present invention shown in FIG. 3; and

FIG. 9 is an illustration of a homopolar generator having a drum shaped armature in accordance with an embodiment of the present invention shown in FIG. 3

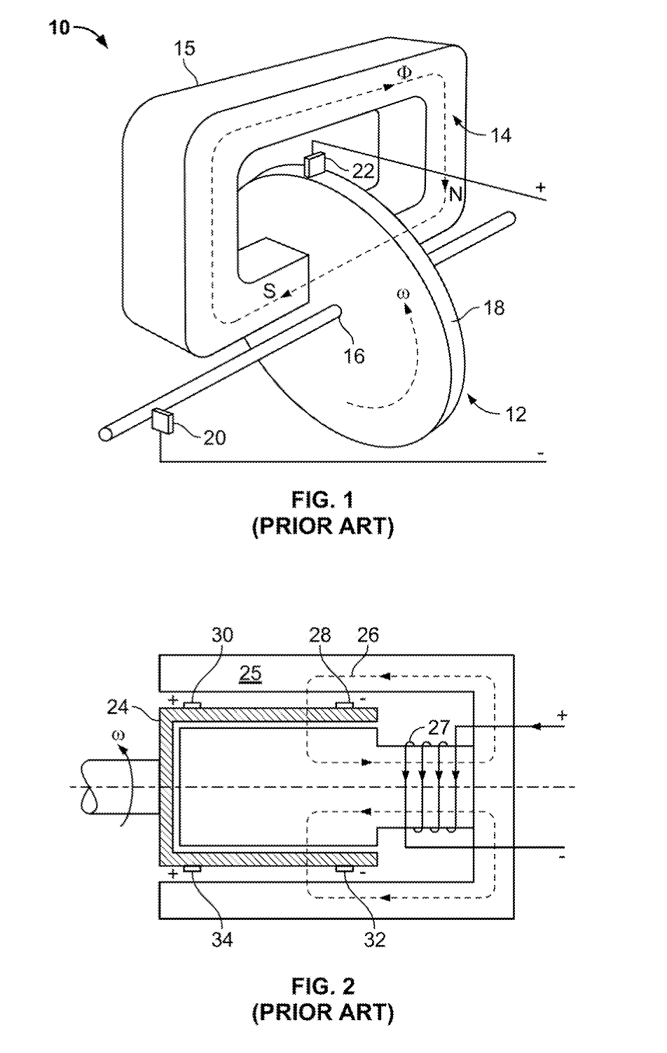

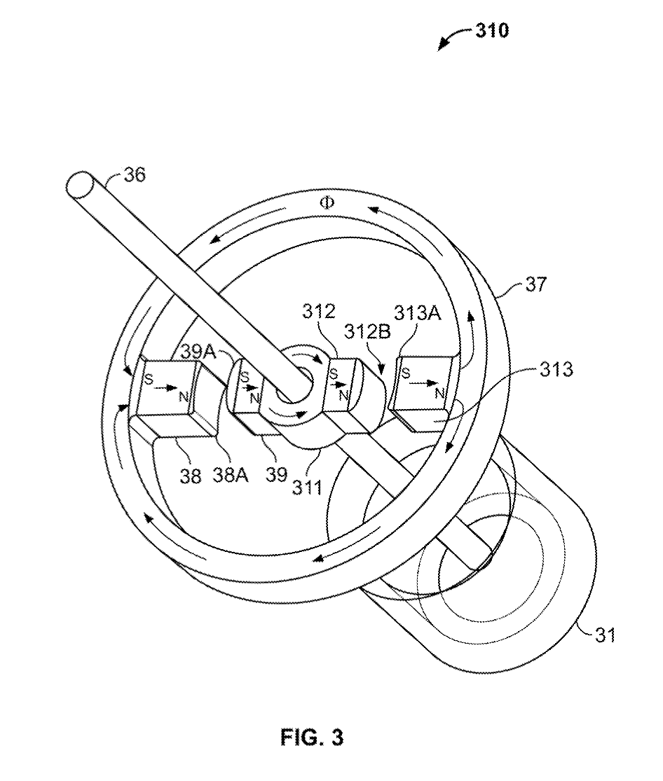

### DETAILED DESCRIPTION

The following brief definition of terms shall apply throughout the application;

The term “comprising” means including but not limited to, and should be interpreted in the manner it is typically used in the patent context;

The phrases “in one embodiment,” “according to one embodiment,” and the like generally mean that the particular feature, structure, or characteristic following the phrase may be included in at least one embodiment of the present invention, and may be included in more than one embodiment of the present invention (importantly, such phrases do not necessarily refer to the same embodiment);

If the specification describes something as “exemplary” or an “example,” it should be understood that refers to a non-exclusive example; and

If the specification states a component or feature “may,” “can,” “could,” “should,” “preferably,” “possibly,” “typically,” “optionally,” “for example,” or “might” (or other such language) be included or have a characteristic, that particular component or feature is not required to be included or to have the characteristic.

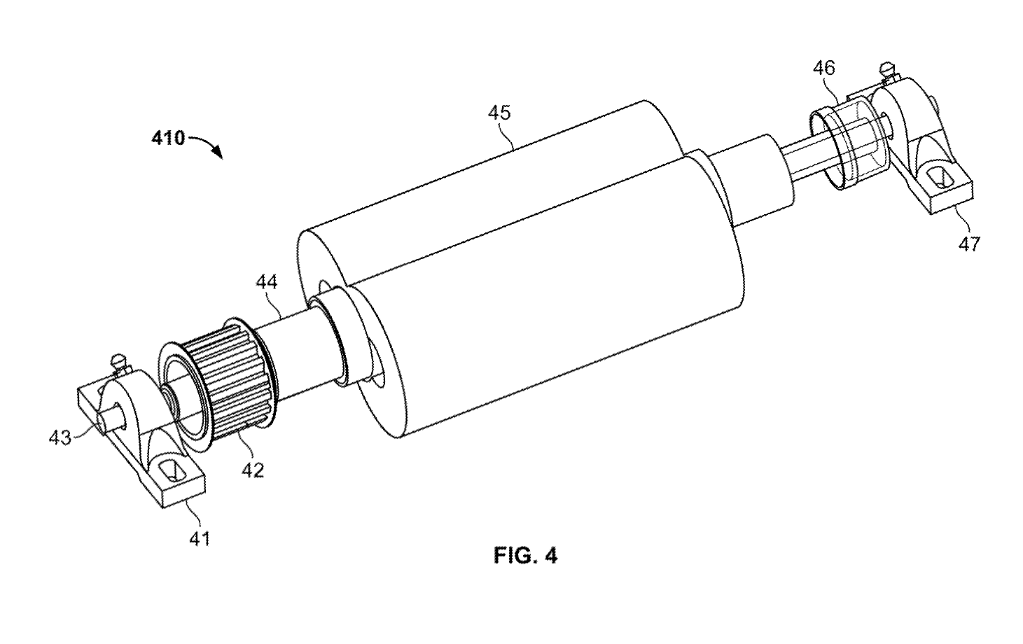

Referring now to FIG. 3 there is shown an illustration of a section of a homopolar generator having, a drum shaped armature and magnetic flux path focusing features in accordance with the present invention. For clarity the coil cage 31 is shown off set along the center shaft 36. It will be understood that during operation the coil cage 31 is centered along center shaft 36 such that magnetic flux as discussed herein bisects coil cage 31 at substantially 90 degrees. It will also be understood that the stator and/or armature of the present invention may be rotated independently around a common axis.

Still referring to FIG. 3, there is shown a symmetrical magnetic flux path φ flowing through magnetic flux assembly generator 310. The magnetic flux generator assembly 310 includes: outer ring assembly 37, neodymium magnet 38, ferrous concave cap 38A, ferrous convex cap 39A, neodymium magnet 39, ferrous shaft bearing 311, neodymium magnet 312, ferrous convex cap 312A, ferrous concave cap 313A, and neodymium magnet 313. It will be appreciated that outer magnets 38 and 313 are advantageously larger than inner magnets 39 and 312 to obtain optimal radial focusing of magnetic flux. In addition, the outer ferrous ring assembly 37 is substantially one half the widths of the two outer magnets 38 and 313 in order to facilitate the magnetic flux path.

Still referring to FIG, 3, it will be understood that concave cap 38A and convex cap 39A are shaped to be the inverse shape of the other. It will also be understood that the degree of concavity of concave cap 38A and the corresponding degree of convexity of the convex cap 39A may be any suitable degree. It will also be appreciated that the concave cap 38A focuses the magnetic flux emanating from neodymium magnet 38 across air gap 38B onto convex cap 39A. The magnetic focusing action of the concave and convex caps, 38A and 39A, respectively, across air gap 38B helps to minimize flux leakage. It will also be appreciated that neodymium magnet 38A may be any suitable size or shape. Similarly, neodymium magnet 39 may be any suitable size or shape.

Still referring to FIG. 3, ferrous shaft bearing 311 may be any suitable ferrous material necessary to complete the flux path. Ferrous shaft bearing 311 may be a suitable hybrid device where the ferrous shaft bearing 311 is magnetically isolated from the center shaft 36 in order to minimize flux leakage.

In alternate embodiments the ferrous shaft bearing 311 may be a solid magnet suitably shaped to match the contours of outer concave magnets 38 and 313 and any associated caps, if any.

Center shaft 36 may be any suitable diameter or length and may comprise any suitable material. Center shaft 36 may be ferrous or non-ferrous material.

Still referring to FIG. 3, neodymium magnet 312 continues the magnetic flux path from shaft bearing 311. Attached to neodymium magnet 312 is convex ferrous cap 312A. Ferrous cap 313A, attached to neodymium magnet 313, focuses the magnetic flux emanating from neodymium magnet 312 across air gap 312B. The magnetic focusing action of the convex and concave caps, 312A and 313A, respectively, across air gap 312B helps to minimize flux leakage. Neodymium magnet 313, connected to outer magnetic ring assembly 37 completes the magnetic flux path. It will be appreciated that magnets, gaps, caps, and outer ring are all substantially coplanar to facilitate the flow of magnetic flux φ.

Outer magnetic ring. assembly 37 may be any suitable ferrous material or structure capable of supporting a bifurcated magnetic flux path.

The two larger outer permanent neodymium magnets 38, 313 mounted 180 degrees “off-set” internally on the outer 1018 steel magnetic field circuiting ring 37. The outer 1018 steel magnetic field circuiting ring 37 may be held “static” and locked in place concentrically on and relative to the “static” central axis drive shaft 36 which may be mounted between two “shaft-locking” base mounted ball bearings.

The two smaller inner core permanent neodymium magnets 39, 312 mounted 180 degrees “off-set”, (and are pole oriented North to South and in line with the two 180 degrees “off-set” larger outer permanent neodymium magnets 38, 313), on the outer circumference of the inner 1018 steel magnetic field circuiting ring 311 which may he “press-fitted” with an inner needle bearing on the “static” central axis drive shaft 36.

Also shown in FIG. 3 is coil cage 31. Coil cage 31 is an independent individually drum wound air coils gathered together tightly centrally as to cover the entire 360 degree circumference of the drum with minimal gaps as discussed herein in order to ensure the optimal mutual induction between the coils within the output circuit. Each set of individual coil leads are connected to opposing bar segments of a 48 bar mica molded commutator-commutated top and bottom by separate carbon brushes (not shown). Coil cage 31 may comprise any suitable type of wire material, such as, for example, copper; and, any suitable gauge.

Still referring to FIG. 3, it will be understood that coil cage 31 may be held stationary while outer magnetic ring assembly 37 is rotated; or, that coil cage 31 may be rotated while outer magnetic ring assembly 37 is held stationary; or, both coil cage 31 and outer magnetic ring assembly 37 are both rotated in opposite directions.

It will also be appreciated that there may be any suitable number of magnetic flux generator assembly 310; and, that each magnetic flux generator assembly 310 may be independent of the other assemblies.

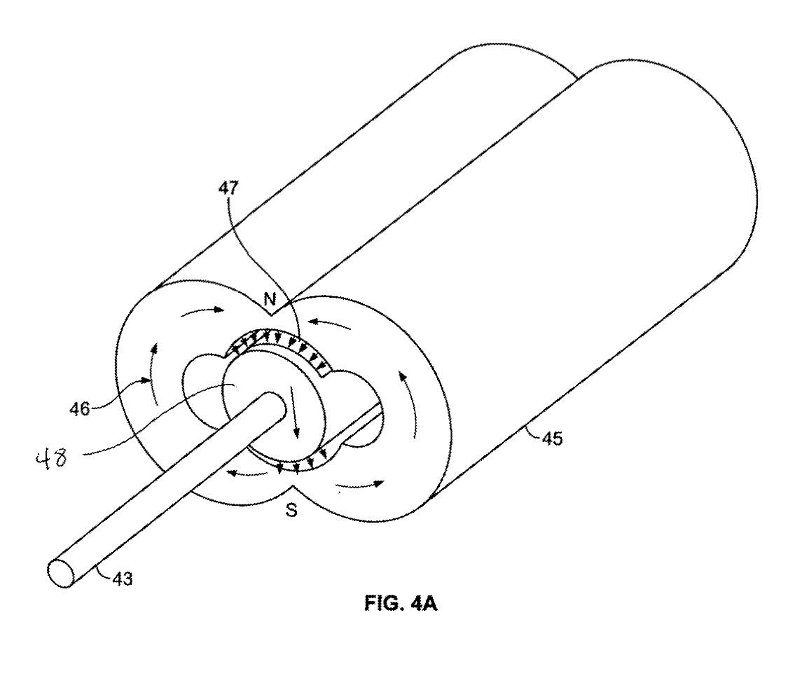

Referring also to FIG. 4, there is shown an illustration of a homopolar magnetic flux generator assembly 410 having a conjoined toroid shaped armature 45 and magnetic flux path focusing features in accordance with the present invention. The homopolar magnetic flux generator assembly 410 includes coil cage 44 extending through conjoined toroid shaped armature 45 and surrounding magnetic core 44A; drive gear 42; and bearing 46. Magnetic core 44A may be any suitable magnetic core material such as, for example, a rare earth magnet core. In addition, magnetic core 44A may comprise a homogenous magnetic core or comprise a suitable hybrid magnetic core, including, for example, rare earth magnets and other suitable magnetic materials. Also included in the homopolar magnetic flux generator assembly 410 shown in FIG. 4 are pillow block bearings 41 and 47; and drive shaft 43. It will be understood that drive shaft 43 may be any suitable ferrous or non-ferrous material.

Referring also to FIG. 4A there is shown a close up illustration of the homopolar magnetic flux generator assembly 410 having a conjoined toroid shaped armature 45 and magnetic flux path focusing features shown in FIG. 4. As shown in FIG. 4, flux lines 46 are focused and nearly all perpendicular to coil cage 44 as the flux lines 46 cross air gap 46A. It will be appreciated that the novel shape of the conjoined toroid shaped armature focuses the magnetic flux lines 46 such that the efficiency of the magnetic flux generator assembly 410 is improved over a conventional air core generator. It will be further appreciated that the highly efficient magnetic flux generator assembly 410 disclosed herein avoids, or minimizes, many of the problems associated with magnetic cores such as eddy currents and hazardous noise due to magnetostriction.

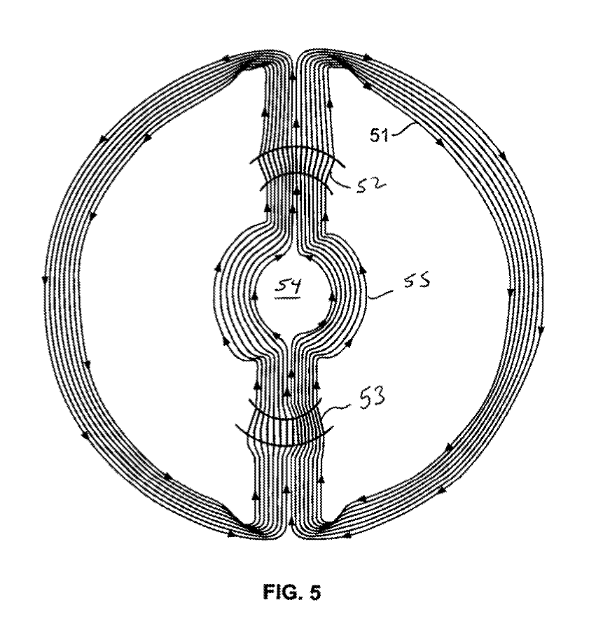

Referring also to FIG. 5, there is shown a diagram of the magnetic flux resulting for the homopolar generator shown in FIG. 3. It will be appreciated that the focused flux lines 51 are substantially perpendicular across gaps 52, 53 through which coil 31 turns, thereby minimizing flux leakage and maximizing induced EMF.

Still referring to FIG. 5 it can be seen how inner 1018 steel magnetic field circuiting ring 311 channels the flux 55 around center shaft area 54 and refocuses flux lines to cross gap 52. it will be appreciated that inner 1018 steel magnetic field, circuiting ring 311 may be any suitable material and shape for channeling and focusing magnetic flux lines 51.

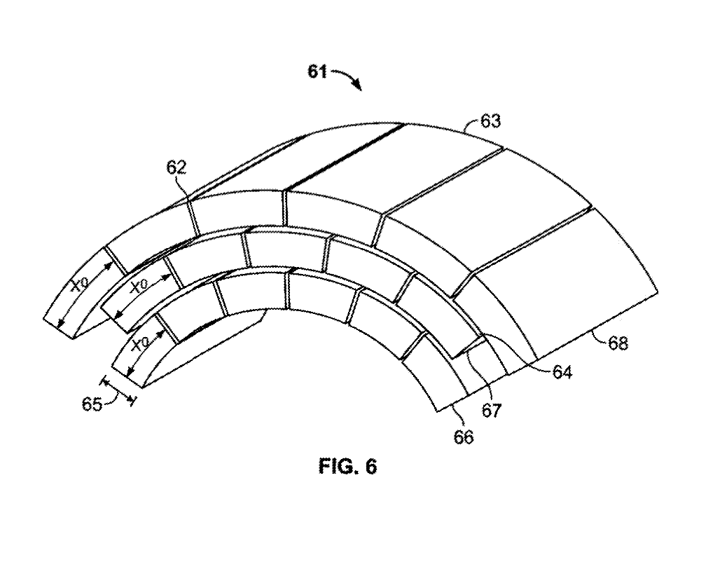

Referring also to FIG. 6, there is shown a pictorial cross section view of a portion 61 of the coil cage shown in FIG. 3 or FIG. 4. in FIG. 4 coil cage 44 is comprised of a suitable number of windings longitudinally wrapped such that each winding is parallel to the axis of the magnetic core 44A and perpendicular to the magnetic flux lines 46. In addition each winding may comprise a suitable conductor such as copper or aluminum; and, each winding may be suitably shaped to optimize the flux conductor interaction. For example, the conductor 63 may be round such as a typical wire, or any other suitable shape such as rectangular.

Similarly, in FIG. 3 coil cage 31 is comprised of a suitable number of windings longitudinally wrapped such that each winding is parallel to the axis of rotation of shaft 36 and perpendicular to the magnetic flux lines shown in FIG. 3. In addition each winding may comprise a suitable conductor such as copper or aluminum; and, each winding may be suitably shaped to optimize the flux conductor interaction. For example, the conductor 63 may be round such as a typical wire, or any other suitable shape such as rectangular.

Still referring to FIG. 6, it will be appreciated that there may be any number of winding layers 66, 67, and 68. Also, gaps 62 between windings 63 in any particular layer are gaps resulting from an insulating coating surrounding the winding 63. In addition, no gap 62 in any one layer would align with a gap 62 in any other layer, above or below. It will be appreciated that the minimal gap 62 between windings and the staggered gap pattern minimizes leakage flux.

Also shown in FIG. 6 are angles X and thickness 65; both of which are determined by a process similar to determining wire gauge and number-of-turns per coil cage unit attached to one set of commutators.

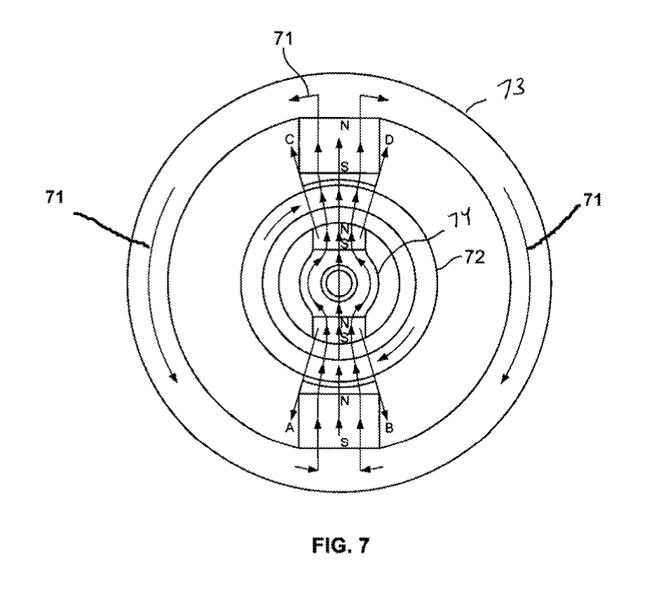

Referring also to FIG. 7 there is shown a top down illustration of a homopolar generator having a drum shaped armature and magnetic flux path focusing features in accordance with an embodiment of the present invention shown in FIG. 3. Flux lines 71 are radially focused along focusing axis paths AD and BC. It will be appreciated that focusing flux lines 71 in this manner maximizes the orthogonal aspect of the flux lines 71 interacting with coil cage 72. It will also be appreciated that the curvature of coil cage 72 may be substantially similar to the curvature of ferrous concave cap 38A, ferrous convex cap 39A, ferrous convex cap 312A, and ferrous concave cap 313A to maximize the flux 71 conductor (coil cage 72) interaction and minimize leakage.

Still referring to FIG. 7, inner 1018 steel magnetic field circuiting ring 74 may be any suitable material and shape for channeling and focusing magnetic flux lines around center shaft (36 in FIG. 3).

It will also be appreciated and understood that Outer magnetic ring assembly 73 may be any suitable ferrous material or structure capable of transmitting and/or focusing magnetic flux 71.

### 120 Degree Applied Magnetic Field Design

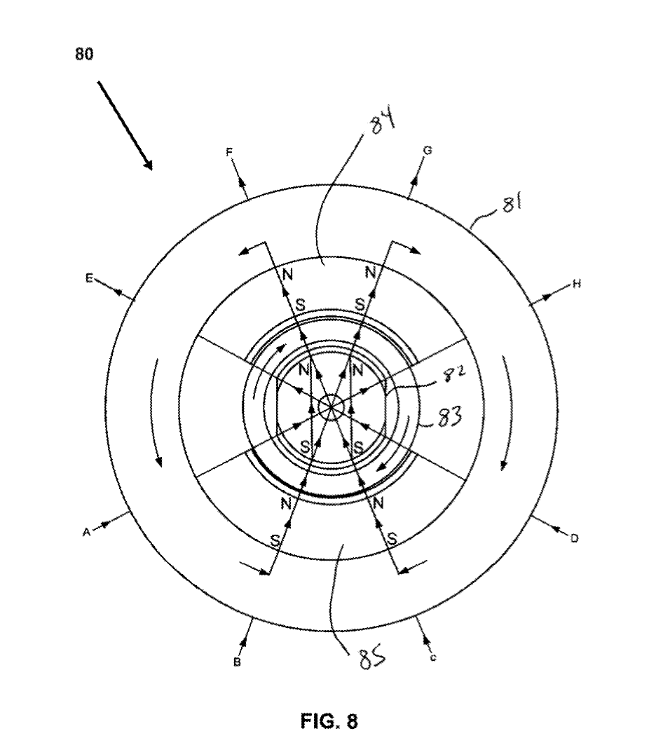

Referring also to FIG. 8 there is shown FIG. 8 an illustration of a 120 degree assembly 80 of the homopolar generator having a drum shaped armature and magnetic flux path focusing features in accordance with an embodiment of the present invention shown in FIG. 3.

The assembly 80 may comprise one or more of operation: (b 1.) a “Stator” mode where either the rotor coil 83 is rotated while the stator assembly (e.g., magnets 84,85, ring 81 and ring 82) is held stationary with respect to the rotor; or (2.) both the rotor coil and the stator assembly are counter-rotated at the same time.

The two outer 120 degree permanent neodymium magnets 84, 85 may be mounted 180 degrees “off-set” internally on the outer 1018 steel magnetic field circuiting ring 81, the one inner core permanent neodymium magnet 82 as one solid piece with 120 degree north and south poles, (with no shaft through its center) is pole aligned North to South with outer magnets 84, 85. It will be appreciated that two outer magnets may be and suitable arc length or curvature, such as, but not limited to 120 degrees. Likewise inner core permanent neodymium magnet 82 may he any suitable matching curvature or arc. For example, arc AD and arc EH as shown in FIG. 8.

Still referring to FIG. 7 and also FIG. 8, it will be understood that rotor 83 in FIG. 8 and rotor 72 in FIG. 7 are drum wound rotors, (e.g., covering the entire 360 degree circumference with substantially no “gaps” between the tightly gathered windings).

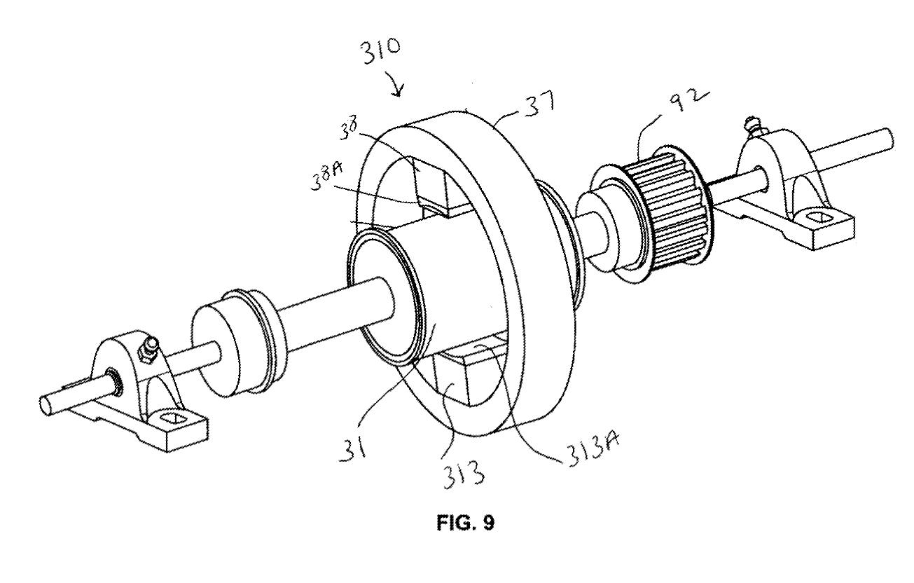

Referring also to FIG. 9 there is shown an illustration of a homopolar generator haying a drum shaped armature in accordance with an embodiment of the present invention shown in FIG. 3. The homopolar generator includes the flux assembly generator 310. The magnetic flux generator assembly 310 includes: outer ring assembly 37, neodymium magnet 38, ferrous concave cap 38A, ferrous concave cap 313A, and neodymium magnet 313. It will be appreciated that outer magnets 38 and 313 are advantageously larger than inner magnets (39 and 312 shown in FIG. 3) to obtain optimal radial focusing of magnetic flux across coil cage 31. In addition, the outer ferrous ring assembly 37 is substantially one half the widths of the two outer magnets 38 and 313 in order to facilitate the magnetic flux path.

Also shown in FIG. 9 is timing or sprocket gear 92. Sprocket gear 92 may be used to rotate coil cage 31 within flux generator assembly 310. It will be appreciated and understood that there may be more than one sprocket gear for turning flux generator assembly 310 while coil cage 31 is rotated relative to the flux generator assembly, e.g., an opposite rotation.

It should be understood that the foregoing description is only illustrative of the invention. Thus, various alternatives and modifications can be devised by those skilled in the art without departing from the invention. Accordingly, the present invention is intended to embrace all such alternatives, modifications and variances that fall within the scope of the appended claims.

It will be appreciated that eddy currents in cores or in ferrous magnetic materials in close proximity to induction coils such as found in the prior art have been substantially eliminated in the present invention.

In addition, another advantage is its output is not unlike that of a battery, (the closest thing to an “Ideal Voltage Source”), in that the output voltage is substantially constant under “load resistance”.

What is claimed is:

1. A direct current homopolar generator comprising:
a stator structure, comprising:
an outer ring for conducting magnetic flux the outer ring comprises an inner surface;
a first outer magnet having first and second opposing surfaces, wherein the first opposable surface is attachable to the inner surface;
a first outer ferrous concave cap attachable to the second opposable surface of the first outer magnet;
a ferrous shaft bearing;
a first inner magnet having third and fourth opposing surfaces, wherein the fourth opposable surface is attachable to the ferrous shaft bearing;
a first ferrous convex cap attachable to the third opposing surface of the first inner magnet, wherein the first outer ferrous concave cap and the first ferrous convex cap are adaptable to form a first flux gap;
a second inner magnet having fifth and sixth opposing surfaces, wherein the fifth opposing surface is attachable to the ferrous shaft bearing substantially 180 degrees from the first inner magnet;
a second ferrous convex cap attachable to the sixth opposing surface;
a second outer magnet having seventh and eighth opposing surfaces, wherein the eighth opposing surface is attachable to the inner surface;
a second ferrous concave cap attachable to the seventh surface, wherein the second outer ferrous concave cap and the second ferrous convex cap are adaptable to form a second flux gap; and
wherein the outer ring the first outer magnet, the first ferrous concave cap, the first ferrous convex cap, the first inner magnet, the ferrous shaft bearing, the second inner magnet, the second ferrous convex cap, the second concave cap, and the second outer magnet are all substantially coplanar in a first plane with a common axis.

2. The direct current homopolar generator as in claim 1 wherein the first outer magnet is substantially the same dimensional size as the second outer magnet.

3. The direct current homopolar generator as in claim 2 wherein the first inner magnet is substantially the same dimensional size as the second inner magnet.

4. The direct current homopolar generator as in claim 3 wherein the first and second outer magnets are dimensionally larger than the first and second inner magnets, respectively.

5. The direct current homopolar generator as in claim 1 wherein the outer ring is substantially a rectangular ring having one half the width of the first and second outer magnets.

6. The direct current homopolar generator as in claim 1 further comprising:
a substantially circular rotor, wherein the rotor comprises:
a plurality of conduction coils, wherein each of the plurality of conduction coils lie in a plurality of second planes, wherein each of the plurality of second planes is orthogonal to the first plane; and
wherein the rotor is substantially coaxial with the stator's common axis and wherein each of the plurality of conduction coils is adapted to rotate through the first and second gaps at substantially 90 degrees relative to the magnetic flux crossing the first and second gaps.

7. A direct current homopolar generator comprising:
a conjoined toroid shaped armature, wherein the conjoined toroid shaped armature is magnetic and generates nearly parallel and focused unidirectional magnetic flux lines; and
an electrically conductive wire coil cage disposed within the conjoined toroid shaped armature, wherein the nearly parallel unidirectional magnetic flux lines are substantially perpendicular to the electrically conductive wire coil cage.

8. A direct current homopolar generator comprising:
a stator, wherein the stator comprises:
an outer ring for bifurcating magnetic flux flow wherein the outer ring comprises a common axis;
a curved first outer magnet adjacent an inner curve of the outer ring;
a curved second outer magnet adjacent the inner curve of the outer ring, substantially opposite of the first outer magnet;
an inner flux transmitter coaxial with the common axis,
a first flux gap between the curved first outer magnet and the inner flux transmitter;
a second flux gap between the curved first outer magnet and the inner transmitter; and
wherein the outer ring, the curved first outer magnet, the curved second outer magnet, the inner flux transmitter, the first flux gap, and the second flux gap are all substantially coplanar in a first plane.

9. The direct current homopolar generator as in claim 8 further comprising:
a rotor, wherein the rotor comprises:
a substantially circular rotor, wherein the rotor comprises:
a plurality of conduction coils, wherein each of the plurality of conduction coils lie in a plurality of second planes, wherein each of the plurality of second planes is orthogonal to the first plane; and
wherein the rotor is substantially coaxial with the stator's common axis and wherein each of the plurality of conduction coils is adapted to rotate through the first and second flux gaps at substantially 90 degrees relative to the magnetic flux flow across the gaps.

10. The direct current homopolar generator as in claim 8 wherein the curved first outer magnet comprises a first concave ferrous cap.

11. The direct current homopolar generator as in claim 8 wherein the curved second outer magnet comprises a second concave ferrous cap.

12. The direct current homopolar generator as in claim S wherein the inner flux transmitter comprises:
a ferrous shaft bearing;
a first inner magnet having tint and second opposing surfaces, wherein the first opposable surface is attachable to the ferrous shaft bearing;
a first ferrous convex cap attachable to the second opposing surface of the first inner magnet, wherein the curved first outer magnet and the first ferrous convex cap are adaptable to form the first flux gap;
a second inner magnet having third and fourth opposing surfaces, wherein the third opposing surface is attachable to the ferrous shaft bearing substantially 180 degrees from the first inner magnet;
a second ferrous convex cap attachable to the fourth opposing surface; and
wherein the curved second outer magnet and the second ferrous convex, cap are adaptable to form the second flux gap.

14. The direct current homopolar generator as in claim 8 wherein the curved first outer magnet adjacent an inner curve of the outer ring comprises a substantially 120 degree arc curved first outer magnet.

15. The direct current homopolar generator as in claim 8 wherein the curved second outer magnet adjacent an inner curve of the outer ring comprises a substantially 120 degree arc curved first outer magnet.

16. The direct current homopolar generator as in claim 8 wherein the inner flux transmitter coaxial comprises:
a magnetic north face, wherein the magnetic north face comprises a curvature substantially similar to the curved first outer magnet adjacent an inner curve of the outer ring; and
a magnetic south face, wherein the magnetic south face comprises a curvature substantially similar to the curved second outer magnet adjacent an inner curve of the outer ring.

17. The direct current homopolar generator as in claim 16 wherein the inner flux transmitter coaxial comprises:
the magnetic north face having a curvature substantially 120 degrees; and
the magnetic south face having a curvature substantially 120 degrees.
